(19) United States
(12) Patent Application Publication
(10) Pub. No.: US 2025/0190864 A1
(43) Pub. Date: Jun. 12, 2025

(54) LEARNING APPARATUS, LEARNING SYSTEM, LEARNING METHOD, AND PROGRAM

(71) Applicant: NIPPON TELEGRAPH AND TELEPHONE CORPORATION, Tokyo (JP)

(72) Inventors: Takumi FUKAMI, Tokyo (JP); Kenta NIWA, Tokyo (JP); Iifan TYOU, Tokyo (JP)

(73) Assignee: NIPPON TELEGRAPH AND TELEPHONE CORPORATION, Tokyo (JP)

(21) Appl. No.: 18/846,222

(22) PCT Filed: Mar. 18, 2022
(86) PCT No.: PCT/JP2022/012677

§ 371 Date: Sep. 11, 2024

(51) Int. Cl. G06N 20/00

(52) U.S. Cl. CPC G06N 20/00

(57) ABSTRACT

A learning apparatus updates a model variable wᵢ by using a dual variable z_{A} and noise Rσᵢ including a random number R in a normal distribution and a standard deviation σᵢ of noise, obtains a parameter λ used when learning of an update difference y_{A} and the standard deviation of noise is performed by using the updated model variable wᵢ and the noise Rσᵢ, exchanges the update difference y_{A} when communication with another learning apparatus constituting the learning system is performed, updates the standard deviation σᵢ of noise by using a dual variable z_{B}, a hyperparameter L, and noise Rλ including a random number R in a normal distribution and the parameter 2, obtains an update difference y_{B} by using the updated standard deviation σᵢ, the hyperparameter L, and the noise Rλ, and exchanges the update difference y_{B} when communication with the other learning apparatus is performed.

### TECHNICAL FIELD

The present invention relates to federated learning.

### BACKGROUND ART

Information from which many advantages such as matching, automatic control, and AI medical care can be obtained by utilizing e-mails and purchase history in personal terminals, inspection materials and IoT information in companies, and diagnosis information in hospitals cannot be utilized due to information security and leakage anxiety. As means for solving this problem, federated learning capable of performing learning in a distributed manner is known.

The federated learning can be implemented at a high speed by distributing learning. However, in the federated learning, it is necessary to transmit an AI model generated by a user to another person, and thus there is a risk that original data is reproduced from the model. In addition, how much information has been transmitted regarding the learning of an AI model has not been known.

Regarding this, the reproduction risk of the original data can be reduced by applying a difference privacy method and adding noise to a model (see Non Patent Literature 1).

### CITATION LIST

### Non Patent Literature

Non Patent Literature 1: K Wei, et al., “Federated Learning with Differential Privacy: Algorithms and Performance Analysis”, IEEE Transactions on Information Forensics and Security (Volume: 15), p. 3454-3469, 2020.

### SUMMARY OF INVENTION

### Technical Problem

However, in the conventional method, the risk of leakage can be reduced as more noise is added, but then there is a problem that the accuracy of the AI model to be learned decreases. In other words, in the known method, it is necessary to freely determine the noise to be added, and the problem of achieving a balance between the leakage risk and the accuracy remains.

An object of the present invention is to provide a learning apparatus, a learning system, a learning method, and a program thereof that optimally adjust safety and accuracy of an AI model learned by an end user terminal by controlling a magnitude of noise to be added, generating a large amount of noise within a range not interfering with AI learning in federated learning, and adding noise to the AI model.

### Solution to Problem

In order to solve the above problem, according to an aspect of the present invention, a learning apparatus constitutes a learning system including N learning apparatuses. The learning apparatus includes a model learning unit that updates a model variable wᵢ by using a dual variable z_{A} and noise Rσᵢ including a random number R in a normal distribution and a standard deviation σᵢ of noise, obtains a parameter λ used when learning of an update difference y_{A} and the standard deviation of noise is performed by using the updated model variable wᵢ and the noise Rσᵢ, and exchanges the update difference y_{A} when communication with another learning apparatus constituting the learning system is performed, and a noise learning unit that updates the standard deviation σᵢ of noise by using a dual variable z_{B}, a hyperparameter L, and noise Rλ including a random number R in a normal distribution and the parameter λ, obtains an update difference y_{B} by using the updated standard deviation σᵢ, the hyperparameter L, and the noise Rλ, and exchanges the update difference y_{B} when communication with the other learning apparatus is performed.

In order to solve the above problem, according to another aspect of the present invention, a learning system includes N learning apparatuses. Each learning apparatus i includes a model learning unit that updates a model variable wᵢ by using a dual variable z_{A} and noise Rσᵢ including a random number R in a normal distribution and a standard deviation σᵢ of noise, and obtains a parameter λ used when learning of an update difference y_{A} and the standard deviation of noise is performed by using the updated model variable wᵢ and the noise Rσᵢ, and a noise learning unit that updates the standard deviation σᵢ of noise by using a dual variable z_{B}, a hyperparameter L, and noise Rλ including a random number R in a normal distribution and the parameter λ, and obtains an update difference y_{B} by using the updated standard deviation σᵢ, the hyperparameter L, and the noise Rλ. The learning apparatus i and another learning apparatus j exchange the update differences y_{B} and y_{A} when the learning apparatus i communicates with the other learning apparatus j.

### Advantageous Effects of Invention

According to the present invention, there is an effect that it is possible to achieve both safety and security and model accuracy and to perform model learning in contrast to a case where known difference privacy and federated learning are simply combined.

### BRIEF DESCRIPTION OF DRAWINGS

FIG. 1 is a diagram illustrating a configuration example of a learning system according to a first embodiment.

FIG. 2 is a diagram illustrating an example of a processing flow of the learning system according to the first embodiment.

FIG. 3 is a diagram for explaining an algorithm of the learning system according to the first embodiment.

FIG. 4 is a functional block diagram of the learning apparatus according to the first embodiment.

FIG. 5 is a diagram illustrating an example of a communication schedule.

FIG. 6 is a diagram illustrating a configuration example of a computer to which the present method is applied.

### DESCRIPTION OF EMBODIMENTS

Hereinafter, embodiments of the present invention will be described. Note that, in the drawings to be used for the following description, components having the same functions or steps for performing the same processing will be denoted by the same reference numerals, and redundant description will be omitted. In the following description, the symbol “-” or the like used in the text would normally be written immediately above the immediately following character, but is notated immediately before the character due to limitations of text notation. In expressions, these symbols are written in their original positions. In addition, processing performed in units of elements of a vector or a matrix is applied to all elements of the vector or the matrix unless otherwise specified.

### <Conventional Federated Learning>

First, conventional federated learning will be described.
(i) The variance of a random number is determined in advance by the number of learning apparatuses that perform the federated learning and the round number during learning.
(ii) A learning apparatus learns a model, adds noise to the model, and transmits the model to which the noise has been added to a learning server.
(iii) The learning server aggregates the received models, further adds noise to the aggregated model, and transmits the model to which the noise has been added after the aggregation to the learning apparatus.
(iv) The model is learned by repeating the above (ii) and (iii).

On the other hand, a learning system in a first embodiment is a distributed system in which a plurality of learning apparatuses operates asynchronously without providing a learning server.

In the learning system in the first embodiment, each learning apparatus learns the standard deviation of noise simultaneously with learning of the model. Furthermore, the resultant obtained by adding noise to an update difference of the model and the resultant obtained by adding noise to an update difference of the standard deviation of the noise are exchanged between the learning apparatuses.

### First Embodiment

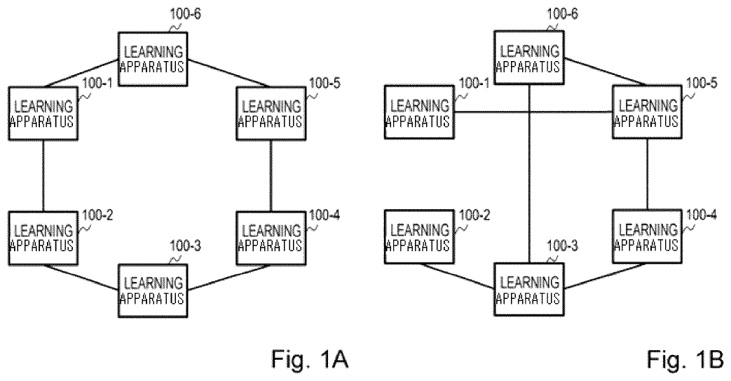

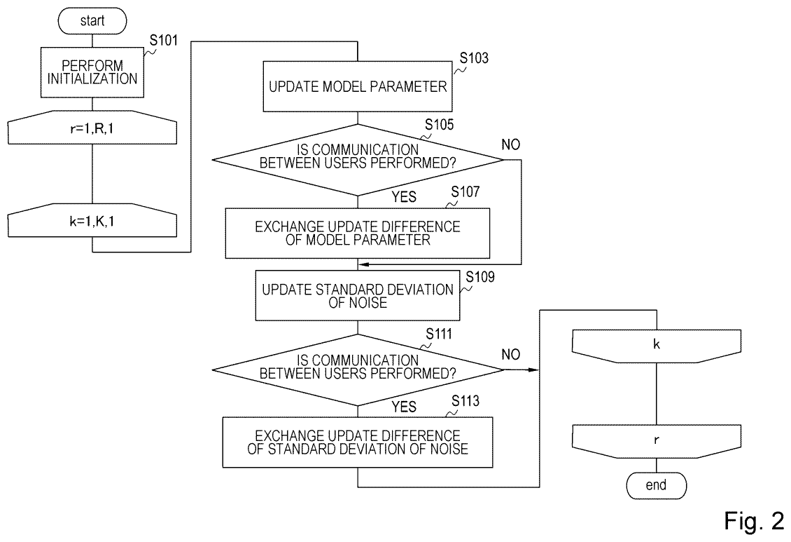

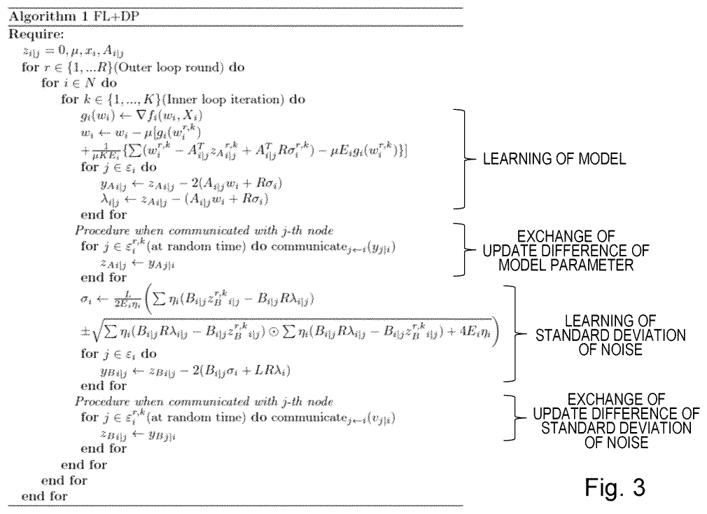

FIG. 1 illustrates a configuration example of a learning system according to the first embodiment. FIG. 2 illustrates an example of a processing flow thereof. FIG. 3 illustrates an example of an algorithm thereof.

The learning system includes N learning apparatuses 100-i. The configuration of a network, the number N of learning apparatuses, and the number Eᵢ of other learning apparatuses with which each learning apparatus 100-i can communicate can be appropriately set. Here, i=1, 2, . . . , N is defined. For example, N=6 and Eᵢ=2 may be obtained by using a ring network as illustrated in FIG. 1A, or a random network of N=6 as illustrated in FIG. 1B may be used. In the random network, the number E; of other learning apparatuses with which the learning apparatus 100-i can communicate differs. For example, the learning apparatus 100-1 can communicate only with the learning apparatus 100-5, but the learning apparatus 100-5 can communicate with three learning apparatuses 100-1, 100-4, and 100-6.

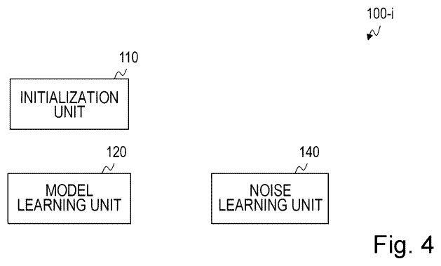

FIG. 4 illustrates a functional block diagram of the learning apparatus 100-i according to the first embodiment.

The learning apparatus 100-i includes an initialization unit 110, a model learning unit 120, and a noise learning unit 140.

The learning apparatus 100-i learns the model by using a data subset xᵢ as an input and performing federated learning with another learning apparatus. The data subset xᵢ is a set of radiuses |xᵢ| including samples of ζ dimensions available for each learning apparatus 100-i∈^{-N}. |⋅| represents the radix of the set ⋅. xᵢ may be different types of data, meaning that xᵢ and xⱼ (i≠j, i∈⁻N, j∈⁻N) are sampled from different distributions. ⁻N represents a set of N learning apparatuses, and N=|⁻N|. Note that a set of other learning apparatuses (set of bidirectional edges) with which the learning apparatus 100-i can communicate is expressed as ⁻Eᵢ={j∈N|(i,j)∈⁻E}, Eᵢ=|⁻Eᵢ| represents the number of other learning apparatuses with which the learning apparatus 100-i can communicate, and E=Σ_{i∈N}Eᵢ is defined. Eᵢ is also referred to as the number of edges.

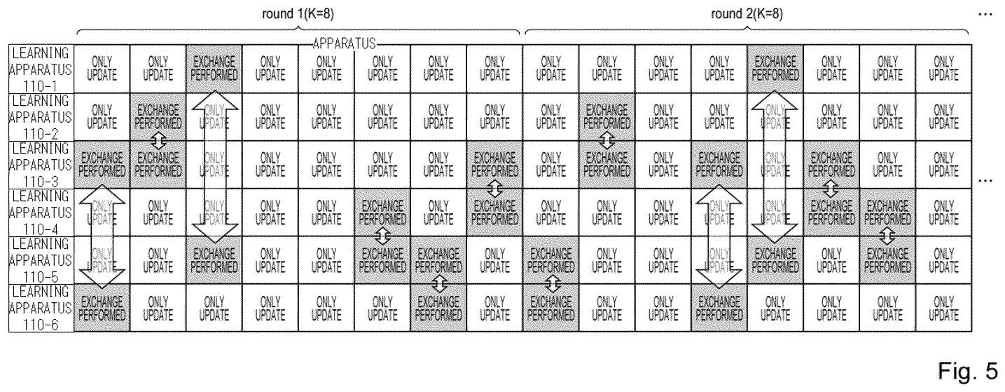

FIG. 5 illustrates an example of a communication schedule. Assuming that the calculation and communication performance of all the learning apparatuses are similar, each learning apparatus 100-i performs the update K times for each communication round r∈{1, . . . , R}. That is, each round r includes K inner iterations in each learning apparatus 100-i. Each learning apparatus 100-i communicates with another learning apparatus 100-j that can communicate for each round r one or more times, and exchanges an update difference of a model parameter and an update difference of the standard deviation of noise. Note that FIG. 3 illustrates that the N learning apparatuses 100-i sequentially perform processing within a round, but actually, the N learning apparatuses 100-i performs processing in parallel by matching the number k of internal iterations.

This distributed optimization method can be applied to any machine learning (ML) model. Before starting a learning procedure, the same model architecture and local cost function fᵢ are defined for all the learning apparatuses 100-i (fᵢ=fⱼ|i,j∈N). A cost function of the learning apparatus 100-i is the following expression.

$${f}_{i} ( {w}_{i} ) = {E}_{χ\_ i ∼ x \_ i} [ {f}_{i} ( {w}_{i} ; {χ}_{i} ) ]$$

Note that the subscript X_Y means X_{Y}. Here, wᵢ∈R^{m} is a model variable of the learning apparatus 100-i, and χᵢ is a mini-batch data sample from xᵢ. It is assumed that the cost function fᵢ: R^{ζ}→R is Lipschitz smooth, and is convex or non-convex (for example, DNN). Thus, the function fᵢ is differentiable and the gradient is calculated by gᵢ(wᵢ)=∇fᵢ(wᵢ;xᵢ). Here, ∇ represents a differential operator.

In the present embodiment, while the N learning apparatuses 100-i learn the model asynchronously, the update difference of the model parameter and the update difference of the standard deviation of the noise are exchanged with another learning apparatus 100-j that can communicate for each round r. In this manner, the accuracy of the model is improved in the entire learning system. The learning system finds, by learning, a model variable that minimizes the global cost function f(w)=(1/N)Σ_{i∈N}fᵢ(wᵢ). Note that the model variable is given by the following expression.

$$w = {[ {{w}^{T}}_{1} , … , {{w}^{T}}_{N} ]}^{T} ∈ {R}^{Nm}$$

Here, ^{T} represents transposition.

The learning apparatus 100-i is a special device configured such that a special program is read by a known or dedicated computer having, for example, a central processing unit (CPU), a main storage device (a random access memory (RAM)), and the like. For example, the learning apparatus 100-i executes each processing under a control of the central processing unit. The data which is input to the learning apparatus 100-i or the data obtained by each processing is stored in, for example, the main storage device. The data stored in the main storage device is read to the central processing unit, and is used for another processing as necessary. At least some of processing units of the learning apparatus 100-i may be configured by hardware such as an integrated circuit. Each storage unit included in the learning apparatus 100-i can be configured with, for example, a main storage device such as a random access memory (RAM) or middleware such as a relational database or a key value store. However, each storage unit is not necessarily provided inside the learning apparatus 100-i, and may be configured with an auxiliary storage device configured with a semiconductor memory element such as a hard disk, an optical disc, or a flash memory, and may be provided outside the learning apparatus 100-i.

Hereinafter, each unit will be described.

### <Initialization Unit 110>

The initialization unit 110 initializes a dual variable z_{i|j} (S101), and outputs the initialized dual variable z_{i|j}. For example, z_{i|j}=0 is defined. z_{i|j} is a variable held and updated by the learning apparatus 100-i, and includes dual variables z_{A_(i|j)} and z_{B_(i|j)}. The dual variable z_{A_(i|j)} is a parameter used when the model as a learning target is learned, and the dual variable z_{B_(i|j)} is a parameter used when the standard deviation of noise is learned.

### <Model Learning Unit 120>

The model learning unit 120 updates a model variable wᵢ^{r,k} by using a data subset xᵢ, a model variable wᵢ^{r,k} of the learning apparatus 100-i, a constraint parameter A_{i|j}∈R^{m×m}, the dual variable z_{A_(i|j)}^{r,k}, and noise Rσᵢ^{r,k} including the random number R in the normal distribution and the standard deviation σᵢ^{r,k} of the noise (S103). Note that the constraint parameter A_{i|j} is a constraint parameter during model learning for the edge (i, j) of the learning apparatus 100-i.

The model learning unit 120 obtains the update difference y_{A_(i|j)}^{r,k} by using the dual variable z_{A_(i|j)}^{r,k}, the constraint parameter A_{i|j}, the updated model variable wᵢ^{r,k}, and the noise Rσᵢ^{r,k}. When communication with the learning apparatus 100-j∈⁻Eᵢ is performed (YES in S105), the model learning unit 120 transmits the update difference y_{A_(i|j)}^{r,k} to the learning apparatus 100-j instead of the model variable wink, receives the update difference y_{A_(j|i)}^{r,k} from the learning apparatus 100-j, and exchanges the update difference (S107).

For example, first, the model learning unit 120 calculates the gradient gᵢ(wᵢ^{r,k})=∇fᵢ(wᵢ^{r,k};χᵢ) by using the mini-batch data sample χᵢ from the data subset xᵢ and the model variable wᵢ^{r,k}∈R^{m} of the learning apparatus 100-i of the model learning unit 120.

Then, the model learning unit 120 updates the model variable wᵢ^{r,k} by using the gradient gᵢ(wᵢ^{r,k}), the constraint parameter A_{i|j}, the dual variable z_{A_(i|j)}^{r,k}, and the noise Rσᵢ^{r,k}.

For example, the model variable wᵢ^{r,k} is updated by the following expression.

$${w}_{i}^{r , k} ← a ( 1 ) {w}_{i}^{r , k} - a ( 2 ) μ [ a ( 3 ) {g}_{i} ( {w}_{i}^{r , k} ) + \frac{a ( 4 )}{μ {KE}_{i}} \{ a ( 5 ) {\sum }_{j ∈ {\overline{E}}_{i}} ( a ( 6 ) {w}_{i}^{r , k} - a ( 7 ) {A}_{i \vert j}^{r} {z}_{{A}_{i \vert j}}^{r , k} + a ( 8 ) {A}_{i \vert j}^{r} R {σ}_{i}^{r , k} ) - a ( 9 ) μ {E}_{i} {g}_{i} ( {w}_{i}^{r , k} ) \} ] \qquad [ Math . 1 ]$$

However, a(1) to a(9) are predetermined coefficients, and may be manually set, or appropriate values may be calculated and set by simulation or the like. For example, a(1) to a(9) are all set to 1, and the following expression is defined.

$${w}_{i}^{r , k} ← {w}_{i}^{r , k} - μ [ {g}_{i} ( {w}_{i}^{r , k} ) + \frac{1}{μ {KE}_{i}} \{ {\sum }_{j ∈ {\overline{E}}_{i}} ( {w}_{i}^{r , k} - {A}_{i \vert j}^{T} {z}_{{A}_{i \vert j}}^{r , k} + {A}_{i \vert j}^{T} R {σ}_{i}^{r , k} ) - μ {E}_{i} {g}_{i} ( {w}_{i}^{r , k} ) \} ] \qquad [ Math . 2 ]$$

Note that μ is a step size. The model variable wᵢ^{r,k} is a parameter used in the model as the learning target. The learning of the model is performed by updating the model variable wᵢ^{r,k} and the dual variable z_{A)(i|j)}^{r,k}. Note that the superscript r, k means a parameter at the k-th iteration of the r round.

Further, the model learning unit 120 obtains the parameters y_{A_(i|j)}^{r,k} and λ_{i|j}^{r,k} by using the updated model variable wᵢ^{r,k}, the dual variable z_{A_(i|j)}^{r,k}, the constraint parameter A_{i|j}, and the noise Rσᵢ^{r,k}.

$${{y}_{A \_ ( i \vert j )}}^{r , k} ← b ( 1 ) {{z}_{A \_ ( i \vert j )}}^{r , k} - b ( 2 ) ( b ( 3 ) {A}_{i \vert j} {{w}_{i}}^{r , k} + b ( 4 ) R {{σ}_{i}}^{r , k} )$$

$${{λ}_{i \vert j}}^{r , k} ← c ( 1 ) {{z}_{A \_ ( i \vert j )}}^{r , k} - c ( 2 ) ( c ( 3 ) {A}_{i \vert j} {{w}_{i}}^{r , k} + c ( 4 ) R {{σ}_{i}}^{r , k} )$$

However, b(1) to b(4) and c(1) to c(4) are predetermined coefficients, and may be manually set, or appropriate values may be calculated and set by simulation or the like. For example, the following expressions are defined.

$$b ( 2 ) = 2 and b ( 1 ) = b ( 3 ) = b ( 4 ) = c ( 1 ) = c ( 2 ) = c ( 3 ) = c ( 4 ) = 1$$

$${{y}_{A \_ ( i \vert j )}}^{r , k} ← {{z}_{A \_ ( i \vert j )}}^{r , k} - 2 ( {A}_{i \vert j} {{w}_{i}}^{r , k} + R {{σ}_{i}}^{r , k} )$$

$${{λ}_{i \vert j}}^{r , k} ← {{z}_{A \_ ( i \vert j )}}^{r , k} - ( {A}_{i \vert j} {{w}_{i}}^{r , k} + R {{σ}_{i}}^{r , k} )$$

Here, j∈⁻Eᵢ.
The parameter y_{A_(i|j)}^{r,k} is a parameter used when the model as the learning target is updated, is an update difference to which the noise Rσᵢ^{r,k} is added, and is a parameter that is held by the learning apparatus 100-i and transmitted to the learning apparatus 100-j. The parameter λ_{i|j}^{r,k} is a parameter used when the standard deviation of noise is learned.

When the learning apparatus 100-i communicates with the learning apparatus 100-j∈⁻Eᵢ (YES in S105), the model learning unit 120 receives the parameter y_{A_(j|i)}^{r,k} held by the learning apparatus 100-j and transmitted to the learning apparatus 100-i, and updates the dual variable z_{A_(i|j)}^{r,k}.

$${{z}_{A \_ ( i \vert j )}}^{r , k} ← {{y}_{A \_ ( i \vert j )}}^{r , k}$$

Furthermore, the model learning unit 120 transmits the parameter y_{A_(i|j)}^{r,k} to the learning apparatus 100-j and exchanges the update difference of the model parameters.

### <Noise Learning Unit 140>

The noise learning unit 140 updates the standard deviation σᵢ^{r,k} of the noise by using the parameter ηᵢ, the constraint parameter B_{i|j}, the dual variable z_{B_(i|j)}^{r,k}, the hyperparameter L, the random number R of the normal distribution, and the parameter λ_{i|j}^{r,k} (S109). Note that the constraint parameter B_{i|j} is a constraint parameter used during a period when the learning apparatus 100-i learns the standard deviation of noise with respect to the edge (i, j). In addition, n is a parameter used for learning the standard deviation of the noise, and, for example, ηᵢ=1/(μEᵢ(K−1)) is defined.

The noise learning unit 140 obtains an update difference y_{B_(i|j)}^{r,k} by using the dual variable z_{B_(i|j)}^{r,k}, the constraint parameter B_{i|j}, the updated standard deviation σᵢ^{r,k}, the hyperparameter L, and the noise Rλ_{i|j}^{r,k} including the random number R of the normal distribution and the parameter λ_{i|j}^{r,k}. When communication with the learning apparatus 100-j∈⁻E; is performed (YES in S111), the noise learning unit 140 transmits the update difference y_{B_(i|j)}^{r,k} to the learning apparatus 100-j, receives the update difference y_{B_(i|j)}^{r,k} from the learning apparatus 100-j, and exchanges the update difference (S113).

For example, first, the noise learning unit 140 updates the standard deviation σᵢ^{r,k} of the noise by the following expression.

$${σ}_{i}^{r , k} ← \frac{d ( 1 ) L}{2 {E}_{i} {η}_{i}} ( d ( 2 ) {\sum }_{j ∈ {\overline{E}}_{i}} d ( 3 ) {η}_{i} ( d ( 4 ) {B}_{i \vert j} {z}_{{B}_{i \vert j}}^{r , k} - d ( 5 ) {B}_{i \vert j} R {λ}_{i \vert j} ) \pm \sqrt{\begin{matrix}d ( 6 ) {\sum }_{j ∈ {\overline{E}}_{i}} d ( 7 ) {η}_{i} ( d ( 8 ) {B}_{i \vert j} R {λ}_{i \vert j} - d ( 9 ) {B}_{i \vert j} {z}_{{B}_{i \vert j}}^{r , k} ) ⊙ \\ {\sum }_{j ∈ {\overline{E}}_{i}} d ( 10 ) {η}_{i} ( d ( 11 ) {B}_{i \vert j} R {λ}_{i \vert j} - d ( 12 ) {B}_{i \vert j} {z}_{{B}_{i \vert j}}^{r , k} ) + d ( 13 ) {E}_{i} {η}_{i}\end{matrix}} ) \qquad [ Math . 3 ]$$

Here, d(1) to a(13) are predetermined coefficients, and may be manually set, or appropriate values may be calculated and set by simulation or the like. For example, d(1) to d(12) are all defined to 1 and d(13)=4 is defined. Further, the following expression is defined.

$${σ}_{i}^{r , k} ← \frac{L}{2 {E}_{i} {η}_{i}} ( {\sum }_{j ∈ {\overline{E}}_{i}} {η}_{i} ( {B}_{i \vert j} {z}_{{B}_{i \vert j}}^{r , k} - {B}_{i \vert j} R {λ}_{i \vert j} ) \pm \sqrt{\begin{matrix}{\sum }_{j ∈ {\overline{E}}_{i}} {η}_{i} ( {B}_{i \vert j} R {λ}_{i \vert j} - {B}_{i \vert j} {z}_{{B}_{i \vert j}}^{r , k} ) ⊙ \\ {\sum }_{j ∈ {\overline{E}}_{i}} {η}_{i} ( {B}_{i \vert j} R {λ}_{i \vert j} - {B}_{i \vert j} {z}_{{B}_{i \vert j}}^{r , k} ) + 4 {E}_{i} {η}_{i}\end{matrix}} ) \qquad [ Math . 4 ]$$

Furthermore, the noise learning unit 140 obtains the parameter y_{B_(i|j)}^{r,k} by the following expression using the dual variable z_{B_(i|j)}^{r,k}, the constraint parameter B_{i|j}, the hyperparameter L, the updated standard deviation σᵢ^{r,k}, and the noise Rλᵢ^{r,k}.

$${{y}_{B \_ ( i \vert j )}}^{r , k} ← e ( 1 ) {{z}_{B \_ ( i \vert j )}}^{r , k} - e ( 2 ) ( e ( 3 ) {B}_{i \vert j} {{σ}_{i}}^{r , k} + e ( 4 ) LR {{λ}_{i}}^{r , k} )$$

Here, e(1) to e(4) are predetermined coefficients, and may be manually set, or appropriate values may be calculated and set by simulation or the like. For example, the following expressions are defined.

$$e ( 1 ) = e ( 3 ) = e ( 4 ) = 1 and e ( 2 ) = 2$$

$${{y}_{B \_ ( i \vert j )}}^{r , k} ← {{z}_{B \_ ( i \vert j )}}^{r , k} - 2 ( {B}_{i \vert j} {{σ}_{i}}^{r , k} + LR {{λ}_{i}}^{r , k} )$$

Here, j∈⁻Eᵢ. The parameter y_{B_(i|j)}^{r,k} is a parameter used when the standard deviation of the noise is updated, is an update difference to which the noise Rλᵢ^{r,k} is added, and is a parameter held by the learning apparatus 100-i and transmitted to the learning apparatus 100-j. Note that L is a hyperparameter, and a value of about 0.01 is usually set. L is a hyperparameter for controlling safety. By setting L to a value of 0.02 or more and 0.03 or less, safety is improved instead of slightly deteriorating learning accuracy.

When the learning apparatus 100-i communicates with the learning apparatus 100-j∈⁻Eᵢ (YES in S111), the noise learning unit 140 receives the parameter y_{B_(j|i)}^{r,k} held by the learning apparatus 100-j and transmitted to the learning apparatus 100-i, and updates the dual variable z_{B_(i|j)}^{r,k} (S113).

$${{z}_{B \_ ( i \vert j )}}^{r , k} ← {{y}_{B \_ ( j \vert i )}}^{r , k}$$

Furthermore, the noise learning unit 140 transmits the parameter y_{B_(i|j)}^{r,k} to the learning apparatus 100-j and exchanges the update difference of the standard deviation of the noise.

In each learning apparatus 100-i, the above processing is repeated K times to form one round of processing, and the R round processing is repeated.

### Effects

With the above configuration, it is possible to achieve both safety and security and model accuracy and to perform model learning.

### Other Modification Examples

The present invention is not limited to the embodiment and the modification example. For example, the various kinds of processing described above may be executed not only in time series in accordance with the description but also in parallel or individually in accordance with processing abilities of the devices that execute the processing or as necessary. In addition, modifications can be made as needed within the gist of the present invention.

### <Program and Recording Medium>

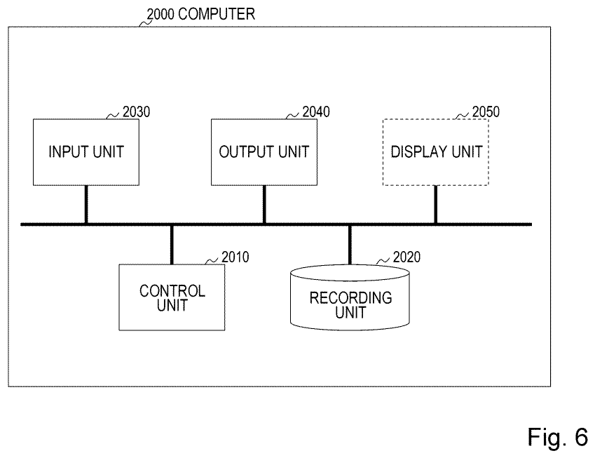

The various processes described above can be performed by causing a recording unit 2020 of a computer 2000 illustrated in FIG. 6 to read a program for executing each step of the method described above and causing a control unit 2010, an input unit 2030, an output unit 2040, a display unit 2050, and the like to operate.

The program in which the processing content is written may be recorded on a computer-readable recording medium. The computer-readable recording medium may be, for example, any recording medium such as a magnetic recording device, an optical disk, a magneto-optical recording medium, or a semiconductor memory.

Moreover, the program is distributed by, for example, selling, transferring, or renting a portable recording medium such as a DVD or a CD-ROM on which the program is recorded. Furthermore, the program may be stored in a storage device of a server computer, and the program may be distributed by transferring the program from the server computer to another computer via a network.

For example, a computer for executing such a program first temporarily stores a program recorded on a portable recording medium or a program transferred from a server computer in a storage device of the computer. Then, when executing processing, the computer reads the program stored in the recording medium of the computer and executes the processing according to the read program. Moreover, as another mode of the program, the computer may read the program directly from a portable recording medium and execute processing according to the program, or alternatively, the computer may sequentially execute processing according to a received program every time the program is transferred from a server computer to the computer. Moreover, the above-described processing may be executed by a so-called application service provider (ASP) type service that implements a processing function only by an execution instruction and result acquisition without transferring the program from a server computer to the computer. Note that the program in the present embodiment includes information that is used for processing by an electronic computer and is equivalent to the program (data or the like that is not a direct command to the computer but has property that defines processing performed by the computer).

Moreover, although the present devices are each configured by executing a predetermined program on a computer in this mode, at least a part of the processing content may be implemented by hardware.

1. A learning apparatus constituting a learning system including N learning apparatuses, the learning apparatus comprising:
processing circuitry configured to:
updates a model variable wᵢ by using a dual variable z_{A} and noise Rσᵢ including a random number R in a normal distribution and a standard deviation σᵢ of noise, obtains a parameter λ used when learning of an update difference y_{A} and the standard deviation of noise is performed by using the updated model variable wᵢ and the noise Rσᵢ, and exchanges the update difference y_{A} when communication with another learning apparatus constituting the learning system is performed; and
updates the standard deviation σᵢ of noise by using a dual variable z_{B}, a hyperparameter L, and noise Rλ including a random number R in a normal distribution and the parameter λ, obtains an update difference y_{B} by using the updated standard deviation σᵢ, the hyperparameter L, and the noise Rλ, and exchanges the update difference y_{B} when communication with the other learning apparatus is performed.

2. The learning apparatus according to claim 1, wherein
the hyperparameter L is any value of 0.02 or more and 0.03 or less.

3. A learning system comprising: N learning apparatuses, wherein
each learning apparatus i includes
processing circuitry configured to:
updates a model variable wᵢ by using a dual variable z_{A} and noise Rσᵢ including a random number R in a normal distribution and a standard deviation σᵢ of noise, and obtains a parameter λ used when learning of an update difference y_{A} and the standard deviation of noise is performed by using the updated model variable wᵢ and the noise Rσᵢ; and
updates the standard deviation σᵢ of noise by using a dual variable z_{B}, a hyperparameter L, and noise Rλ including a random number R in a normal distribution and the parameter λ, and obtains an update difference y_{B} by using the updated standard deviation σᵢ, the hyperparameter L, and the noise Rλ, and
the learning apparatus i and another learning apparatus j exchange the update differences y_{A} and y_{B}, when the learning apparatus i communicates with the other learning apparatus j.

4. A learning method using N learning apparatuses, the learning method comprising:
a model learning step in which processing circuitry included in learning apparatus i updates a model variable wᵢ by using a dual variable z_{A} and noise Rσᵢ including a random number R in a normal distribution and a standard deviation σᵢ of noise, and obtains a parameter λ used when learning of an update difference y_{A} and the standard deviation of noise is performed by using the updated model variable wᵢ and the noise Rσᵢ; and
a model parameter update difference exchange step in which the learning apparatus i and another learning apparatus j exchange the update differences y_{A}, when the learning apparatus i and the other learning apparatus j communicate with each other;
a noise learning step in which the processing circuitry included in the learning apparatus i updates the standard deviation σᵢ of noise by using a dual variable z_{B}, a hyperparameter L, and noise Rλ including a random number R in a normal distribution and the parameter λ, and obtains an update difference y_{B} by using the updated standard deviation σᵢ, the hyperparameter L, and the noise Rλ; and
a noise standard deviation update difference exchange step in which the learning apparatus i and the other learning apparatus j exchange the update difference y_{B}, when the learning apparatus i and the other learning apparatus j communicate with each other.

5. A non-transitory computer-readable recording medium having recorded thereon a program for causing a computer to function as the learning apparatus according to claim 1.
